(19) United States
(12) Patent Application Publication
(10) Pub. No.: US 2013/0272817 A1
(43) Pub. Date: Oct. 17, 2013

(54) BOOKBINDING DEVICE

(71) Applicants: Kuniaki KIMURA, Tokyo (JP); Kenichi WATANABE, Tokyo (JP)

(72) Inventors: Kuniaki KIMURA, Tokyo (JP); Kenichi WATANABE, Tokyo (JP)

(21) Appl. No.: 13/773,756

(22) Filed: Feb. 22, 2013

(30) Foreign Application Priority Data
Apr. 12, 2012 (JP) 2012-90712

(51) Int. Cl. B42C 9/00; B42C 5/00

(52) U.S. Cl. CPC B42C 9/0056; B42C 5/00
USPC 412/13; 412/37

(57) ABSTRACT

A bookbinding device includes: a heater unit which applies a predetermined heat to a bookbinding tape by a heater so that a binding portion of a sheet bundle is pressure-bonded by melting an adhesive adhered to one surface of the bookbinding tape; a heater moving unit which moves the heater; a sheet bundle moving unit which moves the sheet bundle in a nipped state; and a control unit which controls the heater moving unit and the sheet bundle moving unit so as to perform a preliminary heating step in which the binding portion of the sheet bundle is heated by the heater in advance and heat-fixing step in which a bookbinding tape is heat-fixed to the binding portion of the sheet bundle by the heater while the bookbinding tape overlaps the binding portion of the heated sheet bundle.

### BACKGROUND

1. Technical Field

The present invention relates to a bookbinding device which binds sheets discharged from a sheet processing device such as a printer, a copy machine, and a printing machine.

2. Related Art

As a bookbinding device of the related art, there is known a bookbinding device including a sheet holding unit that holds a plurality of sheets, an application unit that applies an adhesive to the rear side of the sheets held by the sheet holding unit, and a bonding unit that bonds a cover sheet to a sheet bundle having an adhesive applied thereto (see Japanese Patent Application Laid-Open No. 2010-201850).

Further, there is known a bookbinding device including a heater unit which applies a predetermined heat to a bookbinding tape so that an end surface of a sheet bundle is pressure-bonded by melting of an adhesive adhering to one surface of the bookbinding tape and a tape guide unit which receives a supplied bookbinding tape. For example, when a sheet is conveyed to a sheet aligning device, a predetermined number of sheets are aligned and gripped on a tray, and then the gripped sheet bundle is moved to a bookbinding device. In the bookbinding device, when the sheet bundle is moved, the bookbinding tape is supplied to the heater unit through the tape guide unit. Then, when a predetermined heat is applied to the bookbinding tape supplied to the heater unit and an adhesive formed on one surface of the bookbinding tape is melted, the end surface of the sheet bundle is moved to the adhesive surface of the bookbinding tape so as to be pressure-bonded, and hence the sheet bundle is bound.

Incidentally, when the bookbinding tape is heat-fixed by the heater unit, the bookbinding tape may not be sufficiently heat-fixed depending on the heat of the heater in accordance with the sheet type of the sheet bundle, the number of sheets of the sheet bundle, and the like, and hence the heat-fixing failure may occur. Further, when the temperature of the heat caused by the heater increases, there may be a problem in that an ink of a letter printed on sheets of a sheet bundle is blurred due to the influence of the heat.

### SUMMARY

The invention is made in view of such circumstances, and it is an object of the invention to provide a bookbinding device capable of improving the bookbinding quality by preventing the ink of the letter printed on sheets from being blurred in the process of heat-fixing the tape to the sheet bundle and reliably heat-fixing the tape with a simple structure.

In order to solve the above-described problem and to attain the above-described object, the invention has the following configuration.

According to a first aspect of the invention, there is provided a bookbinding device including: a heater unit which applies a predetermined heat to a bookbinding tape by a heater so that a binding portion of a sheet bundle is pressure-bonded by melting an adhesive adhered to one surface of the bookbinding tape; a heater moving unit that moves the heater; a sheet bundle moving unit that moves the sheet bundle in a nipped state; and a control unit that controls the heater moving unit and the sheet bundle moving unit so as to perform a preliminary heating step in which the binding portion of the sheet bundle is heated by the heater in advance and a heat-fixing step in which the bookbinding tape is heat-fixed to the binding portion of the sheet bundle by the heater while the bookbinding tape overlaps the binding portion of the heated sheet bundle.

According to a second aspect of the invention, there is provided the bookbinding device according to the first aspect of the invention, wherein in the preliminary heating step, the sheet bundle moving unit moves the sheet bundle to a preliminary heating position, and the heater moving unit moves the heater to the preliminary heating position so that the binding portion of the sheet bundle is heated by the heater in advance, and wherein in the heat-fixing step, the bookbinding tape is heat-fixed to the binding portion of the sheet bundle by the heater while the bookbinding tape overlaps the binding portion of the heated sheet bundle at the preliminary heating position.

According to a third aspect of the invention, there is provided the bookbinding device according to the first aspect or second aspect of the invention, wherein the heating time in which the sheet bundle is heated in advance is set based on the time in which the bookbinding tape is heat-fixed.

According to a fourth aspect of the invention, there is provided the bookbinding device according to any one of the first to third aspects of the invention, further including a heating time setting unit that sets the heating time in which the sheet bundle is heated in advance based on any one of a sheet type of the sheet bundle, the number of sheets of the sheet bundle, a sheet size of the sheet bundle, and a heating temperature.

With the above-described configuration, the invention has the following effects.

In the first aspect of the invention, since performed are the preliminary heating step of heating the binding portion of the sheet bundle by the heater in advance and the heat-fixing step of heat-fixing the bookbinding tape to the binding portion of the sheet bundle by the heater while the bookbinding tape overlaps the binding portion of the heated sheet bundle, the binding portion of the sheet bundle is heated by the heater in advance. Then, since the bookbinding tape may be sufficiently heat-fixed in accordance with the heat of the heater and the ink of the letter printed on the sheet is prevented from being blurred due to the influence of the heat of the heater, the bookbinding quality may be improved.

In the second aspect of the invention, since performed are the preliminary heating step of moving the sheet bundle to the preliminary heating position and moving the heater to the preliminary heating position so as to heat the binding portion of the sheet bundle by the heater in advance and the heat-fixing step of heat-fixing the bookbinding tape to the binding portion of the sheet bundle by the heater in the binding portion of the heated sheet bundle at the preliminary heating position and the preliminary heating operation and the heat-fixing operation are performed at the same position, the bookbinding operation may be performed in a short time.

In the third aspect of the invention, since the heating time in which the sheet bundle is heated in advance is set based on the time in which the bookbinding tape is heat-fixed, the binding portion of the sheet bundle may be reliably heated in advance.

In the fourth aspect of the invention, since the heating time in which the sheet bundle is heated in advance is set based on any one of the sheet type of the sheet bundle, the number of sheets of the sheet bundle, the sheet size of the sheet bundle, and the heating temperature, the binding portion of the sheet bundle may be heated in advance depending on the usage state.

### BRIEF DESCRIPTION OF DRAWINGS

FIG. 1 is a diagram illustrating a structure of a sheet processing device;

FIG. 2 is a diagram exemplarily illustrating a state of sheets bound by using a bookbinding device;

FIG. 3 is a three-dimensional diagram schematically illustrating a bookbinding device which includes a heater unit of a comparative example;

FIG. 4 is a diagram illustrating a process of binding sheets by using the heater unit of the comparative example;

FIG. 5 is a three-dimensional diagram schematically illustrating a bookbinding device which includes a heater unit of an embodiment;

FIG. 6 is an exploded diagram of the heater unit of the embodiment;

FIG. 7 is a side view illustrating a state where a heater of the heater unit of the embodiment is retracted;

FIG. 8 is a side view illustrating a state where the heater of the heater unit of the embodiment is advanced;

FIG. 9 is a diagram illustrating a configuration of a sheet bundle moving unit and a tape-guide-unit moving unit;

FIG. 10 is a control block diagram of the bookbinding device;

FIG. 11 is a diagram illustrating a bookbinding process; and

FIG. 12 is a flowchart illustrating an operation of a bookbinding device.

### DETAILED DESCRIPTION

Hereinafter, an embodiment of a bookbinding device of the invention will be described. The embodiment of the invention illustrates the most preferred embodiment of the invention, and the invention is not limited thereto.

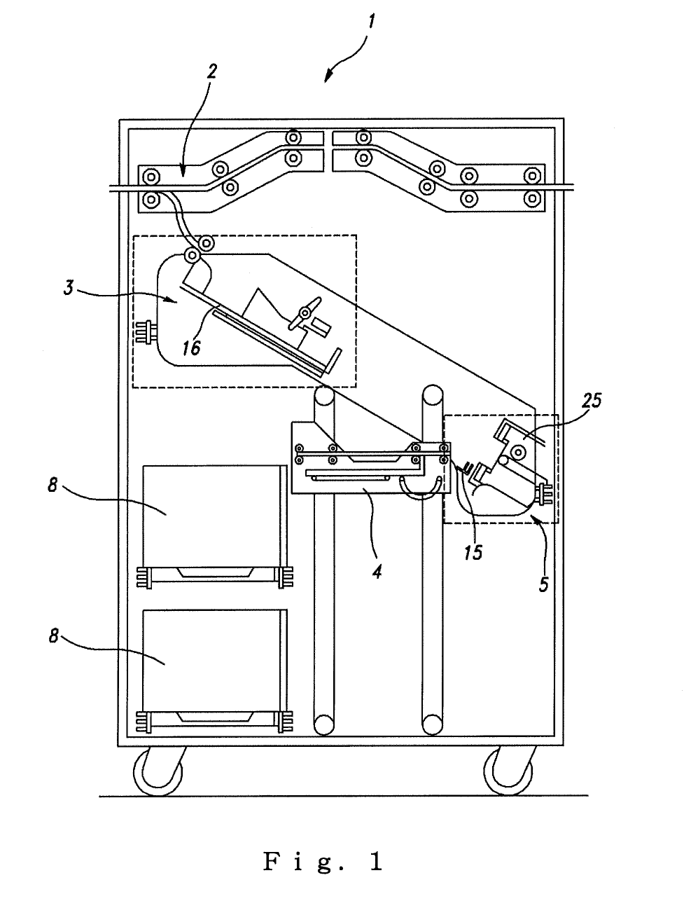

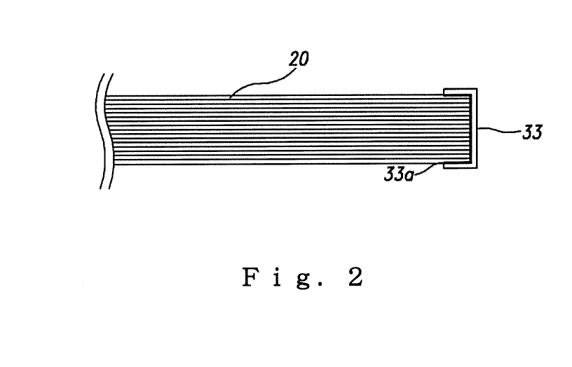

FIG. 1 is a diagram illustrating a structure of a sheet processing device, and FIG. 2 is a diagram exemplarily illustrating a state of sheets bound by using a bookbinding device. A sheet processing device 1 includes a sheet conveying device 2, a sheet aligning device 3, a bookbinding conveying device 4, a storage stacker 8, and a bookbinding device 5 including a tape guide unit 15 and a heater unit 25.

When a sheet is conveyed from the sheet conveying device 2 to the sheet aligning device 3, a predetermined number of sheets are aligned and gripped on a tray 16, and a gripped sheet bundle 20 is moved to the bookbinding device 5.

When the sheet bundle 20 is moved to the bookbinding device 5, a bookbinding tape 33 is supplied to the heater unit 25 by the tape guide unit 15, and heat is applied to the bookbinding tape 33 supplied to the heater unit 25 so that a tape adhesion surface 33a adheres to a binding portion of the sheet bundle 20, thereby completing an operation of binding the sheet bundle 20.

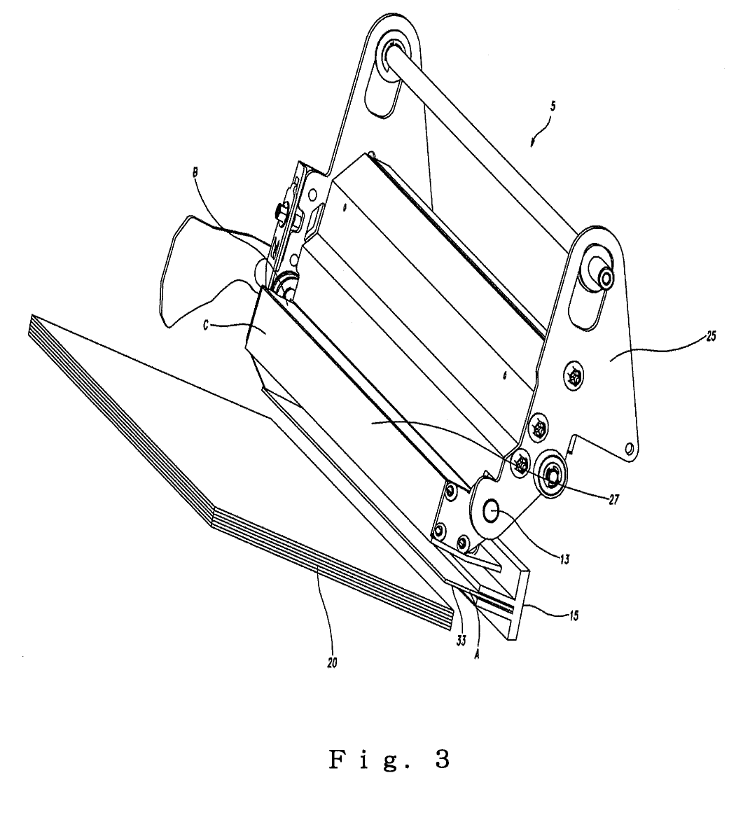

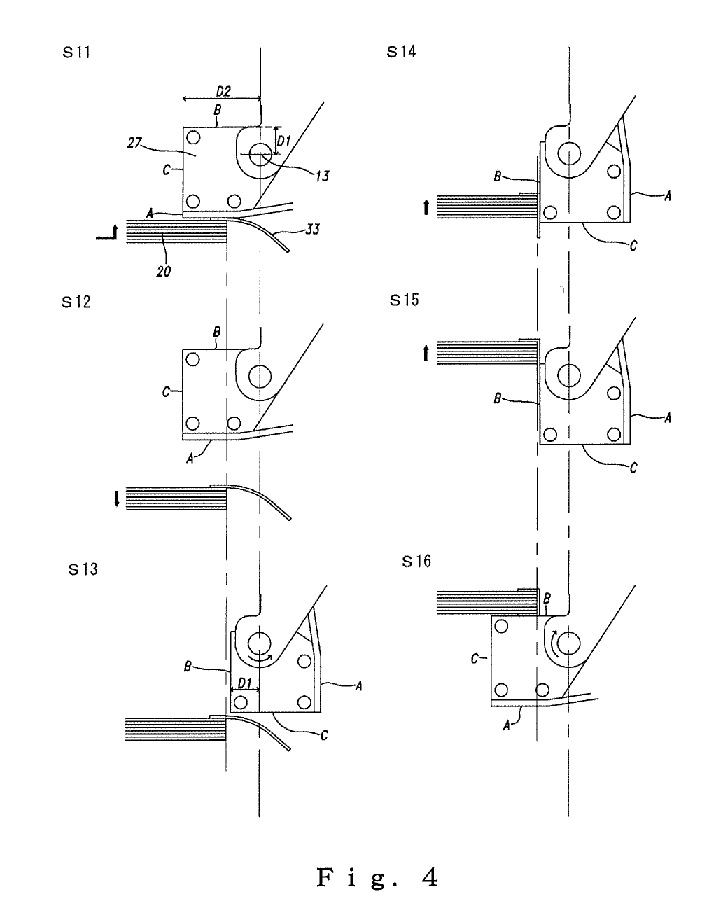

A structure and an operation of the heater unit 25 of the bookbinding device 5 will be described by referring to FIGS. 3 and 4 of a comparative example. The heater unit 25 includes an angular heater 27 which is provided so as to rotate about a support shaft 13.

The angular heater 27 includes surfaces A, B, and C which are perpendicular to one another, where the surfaces B and A face each other and the surfaces C and B are positioned as the front surface in accordance with the direction selected by the rotation of the support shaft 13. Further, a gap D1 between the surface B and the support shaft 13 is smaller than a gap D2 between the surface C and the support shaft 13.

In a state where the surface C of the heater 27 is positioned as the front surface, the bookbinding tape 33 is transferred to a position parallel to the surface A of the heater 27 through the tape guide unit 15, and the sheet bundle 20 is moved to the adhesion position of the bookbinding tape 33. Then, the binding portion of the sheet bundle 20 adheres toward the surface A of the heater 27 along with the bookbinding tape 33.

When a part of the bookbinding tape 33 adheres to the binding portion of the sheet bundle 20 while being pressure-bonded by the surface A of the heater 27, the tape guide unit 15 moves to an original position so as not to disturb the bookbinding operation.

The bookbinding process will be described in more detail. As in step S11 of FIG. 4, the bookbinding tape 33 is pressure-bonded to the sheet bundle 20 and the surface A of the heater 27, so that the bookbinding tape is heat-fixed to the front surface of the end of the sheet bundle 20 by the heat of the heater 27.

Subsequently, the tape guide unit 15 is moved to the original position, and then the bookbinding operation is performed on the sheet bundle 20 through step S12 of moving the sheet bundle 20 by a predetermined gap from the heater 27, step S13 of rotating the heater 27 by 90° in the direction indicated by the arrow so that the surface B is positioned as the front surface, step S14 of moving the sheet bundle 20 moved downward by a predetermined gap upward toward the heater 27 so that the bookbinding tape 33 is heat-fixed to the side surface of the sheet bundle 20, step S15 further moving the sheet bundle 20 of which the side surface is heat-fixed upward, and step S16 of rotating the heater 27 to the original position so that the other end of the sheet bundle 20 adheres to the bookbinding tape 33 by the heat of the surface B.

However, when heat-fixing the bookbinding tape 33 by using the structure of the heater unit 25, since the heater 27 protrudes toward the inside of the sheet bundle 20 through the tape region in accordance with step S11 and step S16 of FIG. 4, a problem arises in that the ink of the letter printed on the sheets of the sheet bundle 20 may be blurred due to the exposure of the heat.

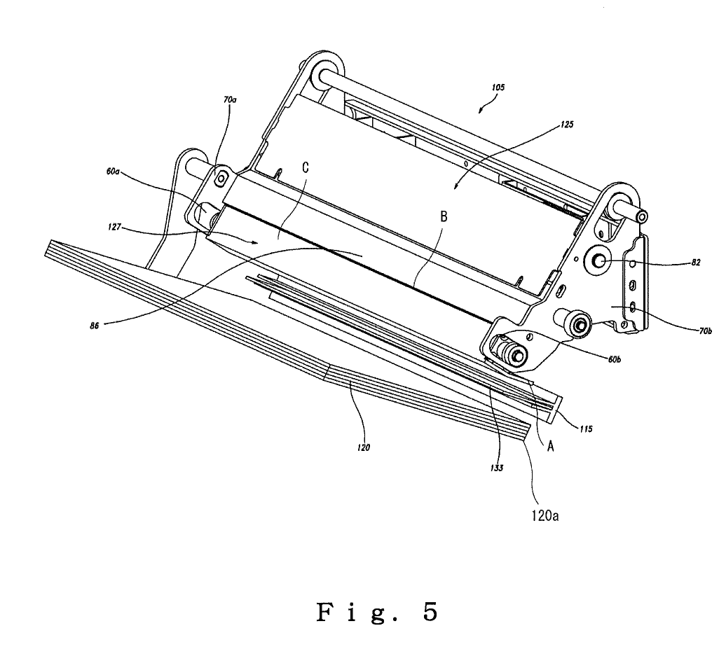

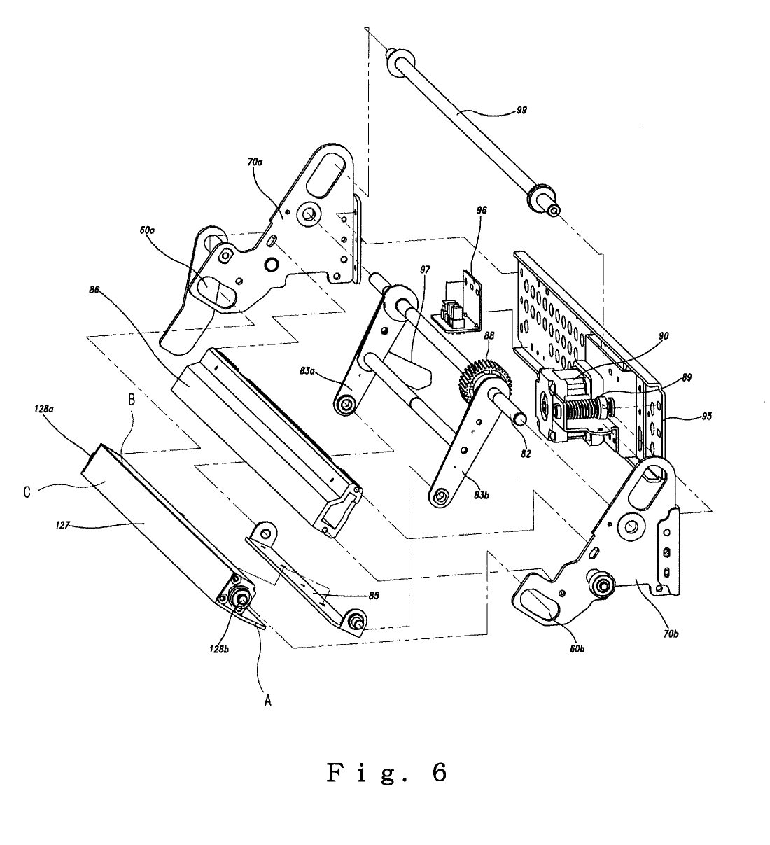

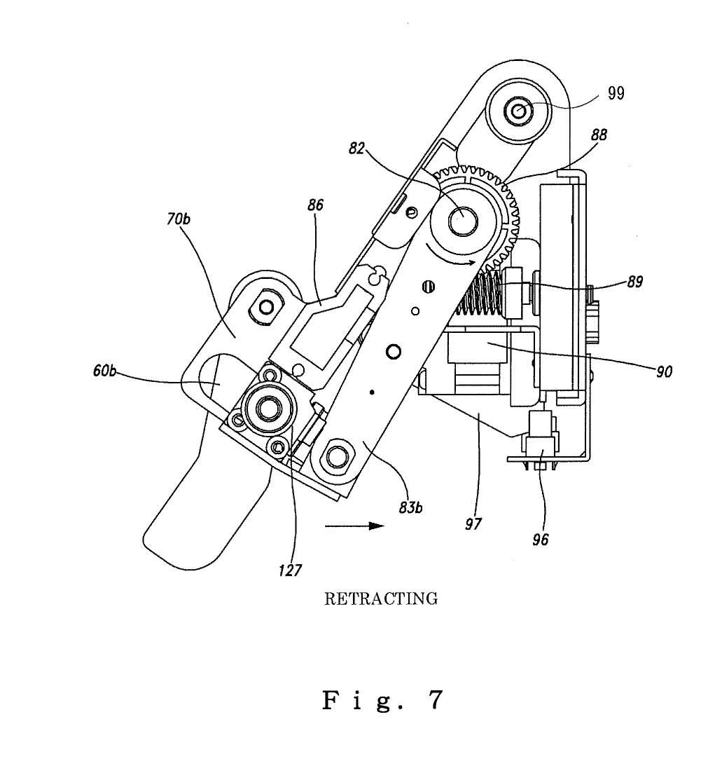

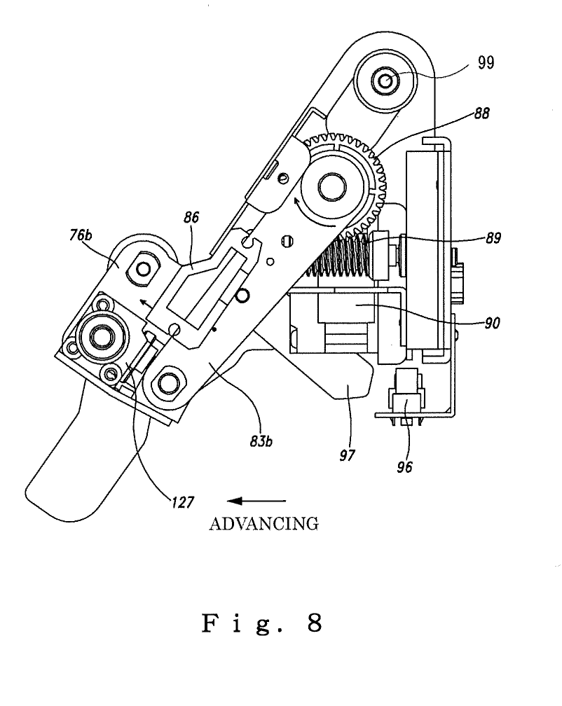

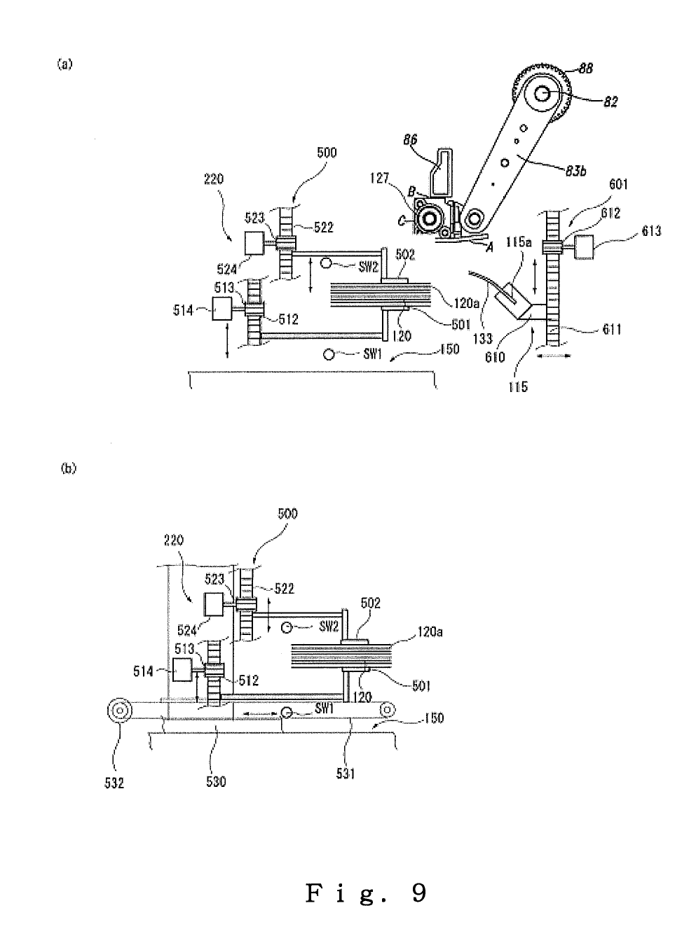

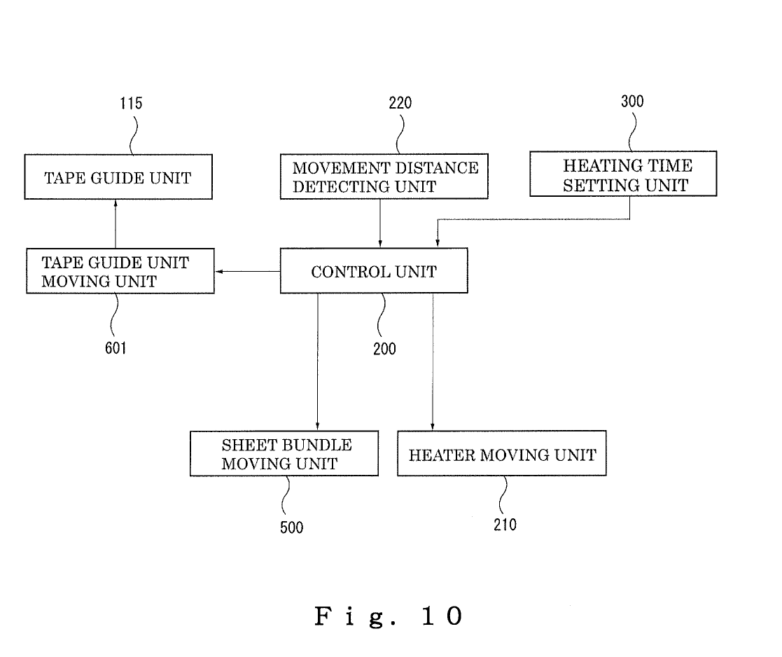

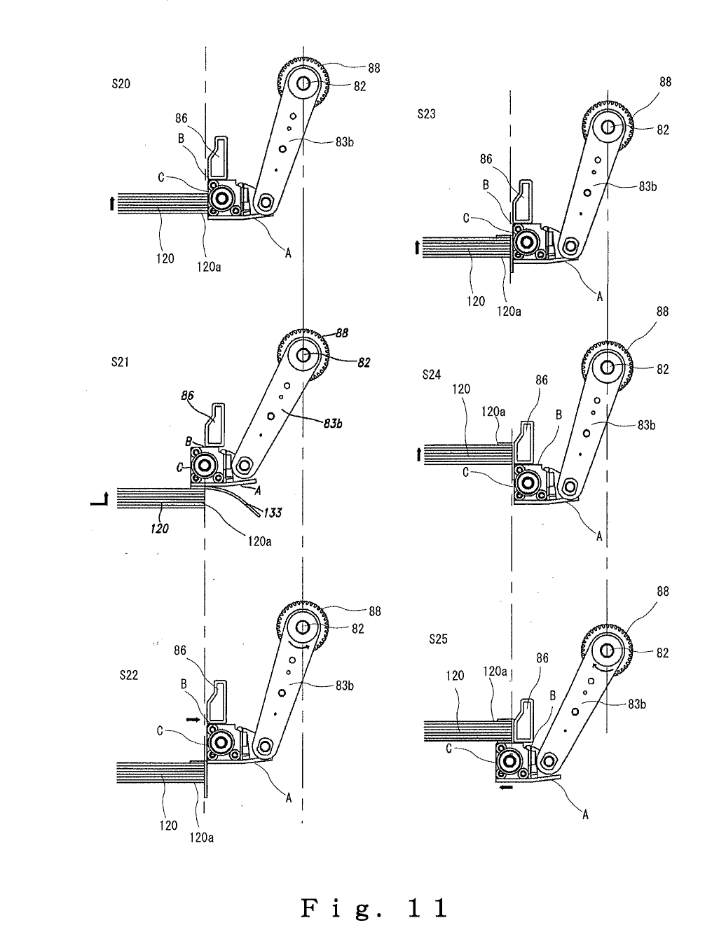

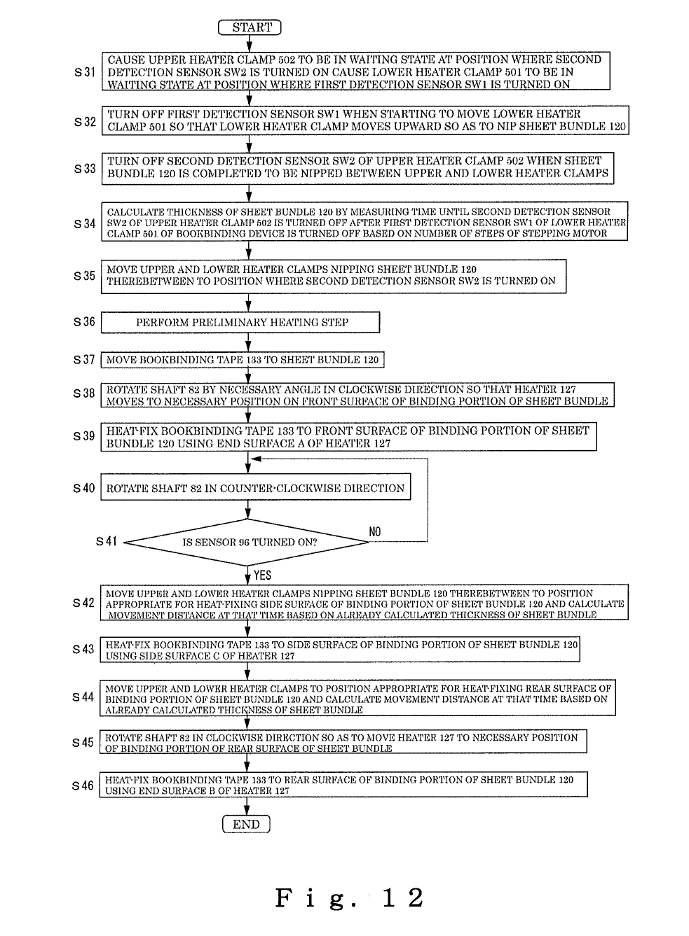

For this reason, the bookbinding device capable of improving the bookbinding quality by preventing the ink of the letter printed on the sheets from being blurred during the process in which the tape is heat-fixed to the sheet bundle 20 will be described by referring to FIGS. 5 to 12. FIG. 5 is a three-dimensional diagram schematically illustrating a bookbinding device 105 including a heater unit, FIG. 6 is an exploded perspective view of the heater unit, FIG. 7 is a side view illustrating a state where the heater of the heater unit is retracted, FIG. 8 is a side view illustrating a state where the heater of the heater unit is advanced, FIG. 9 is a diagram illustrating a configuration of a sheet bundle moving unit and a tape-guide-unit moving unit, FIG. 10 is a control block diagram of the bookbinding device, FIG. 11 is a diagram illustrating a bookbinding process, and FIG. 12 is a flowchart illustrating an operation of the bookbinding device.

First, an operation structure of the bookbinding device 105 will be described based on FIG. 5. A heater unit 125 includes an angular heater 127 which is fitted to slits 60a and 60b formed at the lower ends of support plates 70a and 70b and is installed so as to be advanced or retracted in the linear direction in parallel to a surface of a sheet bundle 120.

The angular heater 127 includes opposite surface B and surface A which are perpendicular to a front surface C. In a state where the surface C of the heater 127 is positioned as the front surface, a bookbinding tape 133 is transported to a position substantially parallel to the end surface A of the heater 127 through a tape guide unit 115. Then, the sheet bundle 120 is moved to the adhesion position of the bookbinding tape 133 while being gripped by a sheet bundle moving unit 500, and a binding portion 120a of the sheet bundle 120 adheres toward the end surface A of the heater 127 along with the bookbinding tape 133.

As illustrated in FIG. 9A, the sheet bundle moving unit 500 includes a lower heater clamp 501 and an upper heater clamp 502 which nip the sheet bundle 120 therebetween, and the binding portion 120a of the sheet bundle 120 which is conveyed to the lower portion of the heater 127 by the lower heater clamp 501 and the upper heater clamp 502 moves in the up and down direction while the binding portion is nipped. The mechanism for moving the lower heater clamp 501 and the upper heater clamp 502 has, for example, a configuration in which the lower heater clamp 501 is connected to a rack 512 through a connection member 511, a pinion 513 meshes with the rack 512, the pinion 513 moves in the up and down direction by the rotation of a stepping motor 514, the upper heater clamp 502 is connected to a rack 522 through a connection member 521, a pinion 523 meshes with the rack 522, and the pinion 523 moves in the up and down direction by the rotation of the stepping motor 524. The stepping motor 514 and the stepping motor 524 are respectively driven by the control unit 200.

A first detection sensor SW1 is disposed at a position corresponding to the lower heater clamp 501, a second detection sensor SW2 is disposed at a position corresponding to the upper heater clamp 502, and the detection information of the first detection sensor SW1 and the second detection sensor SW2 is sent to the control unit 200. The upper heater clamp 502 is in a waiting state at a position where the second detection sensor SW2 is in the detection state (ON), the lower heater clamp 501 is in a waiting state at a position where the first detection sensor SW1 is in the detection state (ON), the sheet bundle 120 is supplied onto the lower heater clamp 501, and the lower heater clamp 501 on which the sheet bundle 120 is loaded moves upward so as to nip the sheet bundle 120 between the heater clamps. When the lower heater clamp 501 starts to move, the first detection sensor SW1 becomes the non-detection state (OFF), and the lower heater clamp 501 moves upward so that the sheet bundle 120 abuts against the upper heater clamp 502. When the upper heater clamp 502 is moved in a pressed state, the sheet bundle 120 is completely nipped between the lower heater clamp 501 and the upper heater clamp 502, so that the second detection sensor SW2 becomes the non-detection state (OFF).

The time until the second detection sensor SW2 of the upper heater clamp 502 becomes the non-detection state (OFF) after the first detection sensor SW1 of the lower heater clamp 501 becomes the non-detection state (OFF) is measured by the number of steps of the stepping motor 514. By using the time, a movement distance detecting unit 220 is configured which detects the movement distance in which the lower heater clamp 501 starts to move upward so that the sheet bundle 120 is nipped between the lower heater clamp 501 and the upper heater clamp 502. The control unit 200 calculates the thickness of the sheet bundle 120 based on the detected movement distance, and controls the sheet bundle moving unit 500 so that the sheet bundle moving unit moves by the distance corresponding to the obtained thickness of the sheet bundle 120.

As illustrated in FIG. 9B, the sheet bundle moving unit 500 may be provided with a mechanism for moving the lower heater clamp 501 and the upper heater clamp 502 in the parallel direction. For example, a timing belt 531 is connected to a support body 530 while being supported by the support body 530 so as to be movable to the bookbinding device 105, and the timing belt 531 is driven by a stepping motor 532 so as to move in the parallel direction with respect to the heater 127. Each stepping motor 532 is driven by the control unit 200.

The sheet bundle 120 is moved downward while being nipped between the lower heater clamp 501 and the upper heater clamp 502 and is moved to a position where the second detection sensor SW2 becomes the detection state (ON). When the timing belt 531 is driven by the stepping motor 532 at the position, the sheet bundle 120 moves in the parallel direction with respect to the heater 127. In this way, the sheet bundle moving unit 500 is controlled so that the sheet bundle 120 is moved in the parallel direction from the nipping position between the lower heater clamp 501 and the upper heater clamp 502 so as to be positioned at the lower portion of the heater 127.

The bookbinding device 105 includes the tape guide unit 115 which receives and holds the supplied bookbinding tape 133 and a tape-guide-unit moving unit 601 that moves the tape guide unit 115 between the reception position and the adhesion position. The tape guide unit 115 receives and holds the bookbinding tape 133 supplied to a holding portion 115a at the reception position. The tape-guide-unit moving unit 601 has a configuration in which the tape guide unit 115 is connected to a rack 611 through a connection plate 610, a pinion 612 meshes with the rack 611, and the pinion 612 moves in the up and down direction by the rotation of the stepping motor 613.

The control unit 200 controls a heater moving unit 210 and the sheet bundle moving unit 500, and performs a preliminary heating step in which the binding portion 120a of the sheet bundle 120 is heated by the heater 127 of the heater unit 125 in advance and a heat-fixing step in which the bookbinding tape 133 is heat-fixed to the binding portion 120a of the sheet bundle 120 by the heater 127 while the bookbinding tape 133 overlaps the binding portion 120a of the heated sheet bundle 120.

In the preliminary heating step, the binding portion 120a of the sheet bundle 120 is moved to the preliminary heating position by the sheet bundle moving unit 500, the heater 127 is moved by the heater moving unit 210, the binding portion 120a of the sheet bundle 120 is heated by the heater 127 in advance, and the heater 127 is returned to the initial position.

In the heat-fixing step, the bookbinding tape 133 overlaps the binding portion 120a of the heated sheet bundle 120 at the preliminary heating position in the heating step, and the bookbinding tape 133 is heat-fixed to the binding portion 120a of the sheet bundle 120 by the heater 127 while the bookbinding tape 133 overlaps the bookbinding portion.

In the operation of heat-fixing the bookbinding tape 133, the binding portion 120a of the sheet bundle 120 is heated by the heater 127 in advance, and the bookbinding tape 133 may be sufficiently heat-fixed to the binding portion with the heat of the heater 127. Further, since the binding portion 120a of the sheet bundle 120 is heated by the heater 127 in advance, it is possible to suppress an increase in the temperature due to the heat of the heater 127 in the heat-fixing step. Accordingly, it is possible to prevent the ink of the letter printed on the sheets from being blurred due to the influence of the heat and hence to improve the bookbinding quality.

Further, in the preliminary heating step, the sheet bundle 120 is moved to the preliminary heating position, the heater 127 is moved to the preliminary heating position, and the binding portion 120a of the sheet bundle 120 is heated by the heater 127 in advance. Then, in the heat-fixing step, the bookbinding tape 133 is heat-fixed to the binding portion 120a of the sheet bundle 120 by the heater 127 in the binding portion 120a of the heated sheet bundle 120 at the preliminary heating position, and the bookbinding operation may be performed in a short time by performing the preliminary heating operation and the heat-fixing operation at the same position.

Further, the heating time in which the sheet bundle 120 is heated in advance is set based on the time in which the bookbinding tape 133 is heat-fixed. For example, when the heat-fixing time is long, the heating temperature is increased, and the preliminary heating time is decreased, thereby shortening the process time and reliably heating the binding portion 120a of the sheet bundle 120 in advance.

Further, a heating time setting unit 300 may be provided, and the heating time in which the sheet bundle 120 is heated by the heating time setting unit 300 in advance is set based on any one of the sheet type of the sheet bundle 120, the number of sheets of the sheet bundle 120, the sheet size of the sheet bundle 120, and the heating temperature. The preliminary heating time may be set to be shorter than the heat-fixing time of the bookbinding tape 133 or longer than the heat-fixing time of the bookbinding tape 133.

As the sheet of the sheet bundle 120, a normal sheet, a coated sheet, and the like may be used, and the preliminary heating time in a case of the normal sheet is set to be longer than that of a case of the coated sheet. For example, in the case of the coated sheet, a coating agent is melted by the preliminary heating operation, and hence the bookbinding tape 133 may be further reliably heat-fixed. The number of sheets of the sheet bundle 120 may be set to be, for example, 10 to 100 sheets, and the preliminary heating time is set to be longer with an increase in the number of sheets. As the sheet size of the sheet bundle 120, B5, A4, B4, A3, and the like may be used, and the preliminary heating time is set to be longer with an increase in the sheet size. The heating temperature is set to be, for example, in the range from 150° C. to 250° C., and the preliminary heating time is set to be shorter with an increase in the heating temperature.

In the heating time setting unit 300, for example, the heating temperature is set to be constant. When the sheet type of the sheet bundle 120, the number of sheets of the sheet bundle 120, and the sheet size of the sheet bundle 120 are set in the printer, the preliminary heating time is automatically set based on the printer setting information. Further, for example, when the preliminary heating time of the sheet bundle 120 is set to be constant and the sheet type of the sheet bundle 120, the number of sheets of the sheet bundle 120, and the sheet size of the sheet bundle 120 are set in the printer, the preliminary heating temperature is automatically set based on the printer setting information.

In this way, the preliminary heating time of the binding portion 120a of the sheet bundle 120 is set based on any one of the sheet type of the sheet bundle 120, the number of sheets of the sheet bundle 120, the sheet size of the sheet bundle 120, and the heating temperature, and hence the binding portion 120a of the sheet bundle 120 may be heated in advance depending on the usage state.

In the heat-fixing step, the tape guide unit 115 is moved by the control of the tape guide unit moving unit 601, the tape guide unit 115 receives and holds the supplied bookbinding tape 133 at the reception position, the bookbinding tape 133 is moved upward while overlapping the front surface of the binding portion 120a of the sheet bundle 120, the bookbinding tape 133 is heat-fixed to the front surface of the binding portion 120a of the sheet bundle 120 by the heater 127 at the pressure-bonding position, and the heat-fixed bookbinding tape 133 is returned from the pressure-bonding position to the reception position. In this way, when a part of the bookbinding tape 133 is pressure-bonded by the binding portion 120a of the sheet bundle 120 and the end surface A of the heater 127, the tape guide unit 115 moves to the original reception position so as not to disturb the bookbinding operation.

A structure of the heater unit 125 which heats the bookbinding tape 133 will be described by referring to FIGS. 6 to 8. The support plates 70a and 70b with the slits 60a and 60b are provided, and a shaft 82 is coupled between the support plates 70a and 70b so as to be rotatable. Both ends 128a and 128b of the heater 127 are coupled to the slits 60a and 60b so as to be advanced or retracted along the slits 60a and 60b. Meanwhile, a pair of arms 83a and 83b is fixed to the shaft 82, and is connected to the heater 127 through a connection member 85.

The ends of the pair of arms 83a and 83b may be directly connected to the heater 127, but the reason why the connection member 85 is interposed is because the arms 83a and 83b are not caught by a structure such as a upper guide plate 86 when the arms 83a and 83b rotate along with the shaft 82.

Meanwhile, the shaft 82 is provided with a worm wheel 88, and a fixed plate 95 provided with a worm gear 89 meshing with the worm wheel 88 is coupled to the support plates 70a and 70b. The fixed plate 85 is provided with a motor 90 for driving a worm 89, and a sensor 96 is fixed to the side portion of the fixed plate 95. The sensor 96 is a sensor to detect the home positions of the arms 83a and 83b, and the home position of the arm is detected by a plate-shaped protrusion 97 which protrudes toward the middle of the arm 83a.

In the heater moving unit 210 for moving the heater 127 in the linear direction, the worm gear 89 rotates the worm wheel 88 so that the arms 83a and 83b rotate in the counter-clockwise direction so as to retract the heater 127 as illustrated in FIG. 7 or the arms 83a and 83b rotate in the clockwise direction so as to advance the heater in a direction parallel to the sheet surface of the sheet bundle 120 as illustrated in FIG. 8. The advancing and retracting intervals may be adjusted in a manner such that the worm gear 89 appropriately controls the rotational driving of the worm wheel 88. A shaft 99 is fixed to the support plates 70a and 70b so as to adjust the position of the heater unit 125 inside the bookbinding device 105.

In the embodiment, in step S20 of FIG. 11, the preliminary heating step is performed. In the preliminary heating step, the sheet bundle moving unit 500 is controlled so that the sheet bundle 120 is moved to the preliminary heating position, and the heater moving unit 210 is controlled so that the heater 127 contacts the binding portion 120a of the sheet bundle 120 so as to heat the binding portion in advance. In the operation of heating the binding portion 120a of the sheet bundle 120, the binding portion may be heated by disposing the heater 127 at the position in a periphery of the binding portion without causing the heater to contact the binding portion.

After the preliminary heating step is performed, the heat-fixing step is performed. In the heat-fixing step, the bookbinding tape 133 is heat-fixed to the binding portion 120a of the sheet bundle 120 by the heater 127 while the bookbinding tape 133 overlaps the binding portion 120a of the heated sheet bundle 120. The heat-fixing step will be described in detail. In step S21 of FIG. 11, when the bookbinding tape 133 is pressure-bonded between the sheet bundle 120 and the end surface A of the heater 127 and is heat-fixed to the front surface of the binding portion 120a of the sheet bundle 120 by the heat of the heater 127, the tape guide unit 115 is retracted to a position where the tape guide unit does not disturb the operation of heat-fixing the bookbinding tape 133.

In particular, the rotation of the worm gear 89 is controlled by the preliminarily programmed control so that the end of the heater 127 moves to a position where the end of the heater 127 matches the end of the bookbinding tape 133.

Subsequently, the worm wheel 88 is driven so as to retract the heater 127 to the side surface of the binding portion 120a of the sheet bundle 120 in the direction indicated by the arrow (step S22). Subsequently, the sheet bundle 120 is moved in the direction indicated by the arrow so that the side surface of the binding portion 120a of the sheet bundle 120 contacts the front surface C of the heater 127 (step S23). Subsequently, the side surface of the binding portion 120a of the sheet bundle 120 is heat-fixed, and then the sheet bundle 120 is further moved upward so that the side surface of the binding portion 120a of the sheet bundle 120 is substantially positioned at the end of the opposite surface B of the heater 127 (step S24). Subsequently, the worm wheel 88 is driven, and the heater 127 is advanced to the rear surface of the binding portion 120a of the sheet bundle 120 in the direction indicated by the arrow so that the bookbinding tape 133 is heat-fixed to the rear surface of the binding portion 120a of the sheet bundle 120 (step S25).

Further, in the heat-fixing step, the bookbinding tape 133 overlaps the side surface of the binding portion 120a of the heated sheet bundle 120 in the heating step, and the bookbinding tape 133 is heat-fixed to the front surface of the binding portion 120a of the sheet bundle 120 by the heater 127 while the bookbinding tape 133 overlaps the side surface. Then, the bookbinding tape 133 may be heat-fixed to the rear surface of the binding portion 120a of the sheet bundle 120.

Next, an operation of the bookbinding device 105 will be described based on the flowchart illustrated in FIG. 12. When the sheet bundle 120 is being sent to the sheet bundle moving unit 500 through the operation of the bookbinding device 105, the upper heater clamp 502 is in a waiting state at a position where the second detection sensor SW2 becomes the detection state (ON), and the lower heater clamp 501 is in a waiting state at a position where the first detection sensor SW1 becomes the detection state (ON) (S31).

When the sheet bundle 120 is sent to the sheet bundle moving unit 500, the sheet bundle 120 is loaded on the lower heater clamp 501, and the lower heater clamp 501 moves upward in this state so as to nip the sheet bundle 120 between the heater clamps. When the lower heater clamp 501 starts to move, the first detection sensor SW1 becomes the non-detection state (OFF) (S32).

When the lower heater clamp 501 moves upward so that the sheet bundle 120 abuts against the upper heater clamp 502 and the upper heater clamp 502 is moved in a pressed state, the sheet bundle 120 is completed to be nipped between the lower heater clamp 501 and the upper heater clamp 502, so that the second detection sensor SW2 becomes the non-detection state (OFF) (S33).

The time until the second detection sensor SW2 of the upper heater clamp 502 becomes the non-detection state (OFF) after the first detection sensor SW1 of the lower heater clamp 501 becomes the non-detection state (OFF) is measured by the number of steps of the stepping motor 514. Accordingly, the movement distance in which the lower heater clamp 501 starts to move upward so that the sheet bundle 120 is nipped between the lower heater clamp 501 and the upper heater clamp 502 is detected, and the thickness of the sheet bundle 120 is calculated based on the detected movement distance (S34).

The sheet bundle 120 is moved downward while being nipped between the lower heater clamp 501 and the upper heater clamp 502 and is moved to a position where the second detection sensor SW2 becomes the detection state (ON) (S35).

In this way, the sheet bundle moving unit 500 is controlled so that the sheet bundle 120 is moved to the preliminary heating position, and the heater moving unit 210 is controlled so that the heater 127 contacts the binding portion of the sheet bundle 120 so as to be heated in advance (S36).

When the preliminary heating step ends, the heat-fixing step is performed. In the heat-fixing step, the tape guide unit 115 is moved, and the bookbinding tape 133 overlaps the front surface of the binding portion 120a of the sheet bundle 120 (S37).

The shaft 82 is rotated by a necessary angle in the clockwise direction, and the heater 127 is advanced so that the end surface A of the heater 127 is advanced so as to be moved to the necessary position of the front surface of the binding portion 120a of the sheet bundle 120 (S38). At the advanced position, the bookbinding tape 133 is heat-fixed to the front surface of the binding portion 120a of the sheet bundle 120 by the end surface A of the heater 127 (S39), and the shaft 82 is rotated in the counter-clockwise direction (S40).

The shaft 82 is rotated in the counter-clockwise direction so as to retract the heater 127, and it becomes the retracting position where the sensor 96 becomes the detection state (ON) (S41). Then, the lower heater clamp 501 and the upper heater clamp 502 are moved upward while the sheet bundle 120 is nipped therebetween, and are moved to a position appropriate for heat-fixing the side surface of the binding portion 120a of the sheet bundle 120. Here, the movement distance at this time is calculated based on the already calculated thickness of the sheet bundle 120 (S42).

By using the side surface C of the heater 127, the bookbinding tape 133 is heat-fixed to the side surface of the binding portion 120a of the sheet bundle 120 (S43), and the lower heater clamp 501 and the upper heater clamp 502 move upward while the sheet bundle 120 is nipped therebetween so as to move to a position appropriate for heat-fixing the rear surface of the binding portion 120a of the sheet bundle 120. Here, the movement distance at this time is calculated based on the already calculated thickness of the sheet bundle 120 (S44).

The shaft 82 is rotated in the clockwise direction, and the heater 127 is advanced so as to move the necessary position of the rear surface of the binding portion 120a of the sheet bundle 120 (S45). Then, the bookbinding tape 133 is heat-fixed to the rear surface of the binding portion 120a of the sheet bundle 120 by the end surface B of the heater 127 (S46).

In the heat-fixing step, the sheet bundle 120 is nipped between the lower heater clamp 501 and the upper heater clamp 502, and the bookbinding tape 133 overlaps the front surface of the binding portion 120a of the sheet bundle 120 while being positioned at the lower portion of the heater 127 at the advancing position. In this state, the sheet bundle 120 is moved upward so that the bookbinding tape 133 abuts against the rear surface of the heater 127, and the bookbinding tape 133 is heat-fixed to the front surface of the binding portion 120a of the sheet bundle 120 by the heater 127 (S21 of FIG. 11). Then, the heater 127 is moved in the linear direction so as to be retracted to the side surface of the binding portion 120a of the sheet bundle 120 (S22 of FIG. 11), the sheet bundle 120 is moved upward while the sheet bundle 120 is nipped so that the bookbinding tape 133 is heat-fixed to the side surface of the binding portion 120a of the sheet bundle 120 by the heater 127 (S23 of FIG. 11), the sheet bundle 120 is further moved upward so that the rear surface of the binding portion 120a of the sheet bundle 120 moves to a position deviated from the surface C of the heater 127 (S24 of FIG. 11), and the heater 127 is moved so as to be advanced in the linear direction so that the bookbinding tape 133 is heat-fixed to the rear surface of the binding portion 120a of the sheet bundle 120, thereby completing the bookbinding operation.

In this way, it is possible to prevent the ink of the letter printed on the sheet from being blurred in the process of heat-fixing the tape to the sheet bundle 120 and to improve the bookbinding quality by the simple structure in which the sheet bundle 120 is moved in the up and down direction and the heater 127 is moved between the advancing position and the retracting position in the linear direction. Further, since the guide plate 86 guides the movement of the heater 127 in the horizontal direction, it is possible to accurately move the heater 127 and to simplify the movement structure.

Further, the movement distance in which the lower heater clamp 501 starts to move upward so that the sheet bundle 120 is nipped between the lower heater clamp 501 and the upper heater clamp 502 is detected, the thickness of the sheet bundle 120 is obtained based on the movement distance, and the heater clamp is moved upward in the vertical direction by the distance corresponding to the thickness of the sheet bundle 120, thereby moving the sheet bundle 120 in the vertical direction depending on the thickness of the actual sheet bundle 120.

Further, the tape guide unit moving unit 601 is controlled so that the tape guide unit 115 is moved so as to receive and hold the supplied bookbinding tape 133 at the reception position, is moved to the adhesion position so as to heat-fix the bookbinding tape 133 to the front surface of the binding portion 120a of the sheet bundle 120 by the heater 127 at the adhesion position, and is returned to the reception position after the heat-fixing operation. Accordingly, it is possible to reliably heat-fix the bookbinding tape 133 to the binding portion 120a of the sheet bundle 120 without any disturbance of the tape guide unit 115.

The invention may be applied to a bookbinding device which binds sheets discharged from a sheet processing device such as a printer, a copy machine, and a printing machine. Accordingly, it is possible to prevent an ink of a letter printed on sheets from being blurred in a process of heat-fixing a tape to a sheet bundle and to reliably perform a heat-fixing operation with a simple structure. Thus, it is possible to improve bookbinding quality.

1. A bookbinding device comprising:
a heater unit which applies a predetermined heat to a bookbinding tape by a heater so that a binding portion of a sheet bundle is pressure-bonded by melting an adhesive adhered to one surface of the bookbinding tape;
a heater moving unit which moves the heater;
a sheet bundle moving unit which moves the sheet bundle in a nipped state; and
a control unit which controls the heater moving unit and the sheet bundle moving unit so as to perform a preliminary heating step in which the binding portion of the sheet bundle is heated by the heater in advance and a heat-fixing step in which the bookbinding tape is heat-fixed to the binding portion of the sheet bundle by the heater while the bookbinding tape overlaps the binding portion of the heated sheet bundle.

2. The bookbinding device according to claim 1, wherein
in the preliminary heating step, the sheet bundle moving unit moves the sheet bundle to a preliminary heating position, and the heater moving unit moves the heater to the preliminary heating position so that the binding portion of the sheet bundle is heated by the heater in advance, and
in the heat-fixing step, the bookbinding tape is heat-fixed to the binding portion of the sheet bundle by the heater while the bookbinding tape overlaps the binding portion of the heated sheet bundle at the preliminary heating position.

3. The bookbinding device according to claim 1,
wherein the time in which the sheet bundle is heated in advance is set based on the time in which the bookbinding tape is heat-fixed.

4. The bookbinding device according to claim 1, further comprising a heating time setting unit which sets the time in which the sheet bundle is heated in advance based on any one of a sheet type of the sheet bundle, the number of sheets of the sheet bundle, a sheet size of the sheet bundle, and a heating temperature.
